(19) United States
(12) Patent Application Publication
(10) Pub. No.: US 2013/0207962 A1
(43) Pub. Date: Aug. 15, 2013

(54) USER INTERACTIVE KIOSK WITH THREE-DIMENSIONAL DISPLAY

(71) Applicants: Peter Michael Oberdorfer, San Francisco, CA (US); John Gaeta, Ross, CA (US); David Tin Nyo, San Francisco, CA (US); Michael David Bennett, Sunnyvale, CA (US); Ryo Alexander Okita, San Francisco, CA (US)

(72) Inventors: Peter Michael Oberdorfer, San Francisco, CA (US); John Gaeta, Ross, CA (US); David Tin Nyo, San Francisco, CA (US); Michael David Bennett, Sunnyvale, CA (US); Ryo Alexander Okita, San Francisco, CA (US)

(73) Assignee: Float Hybrid Entertainment Inc., San Francisco, CA (US)

(21) Appl. No.: 13/371,304

(22) Filed: Feb. 10, 2012

(51) Int. Cl. G06T 15/00

(52) U.S. Cl. 345/419

(57) ABSTRACT

Disclosed herein are systems, methods, and non-transitory computer-readable storage media for presenting three-dimensional images to a user. The method detects a user gesture, converts the user gesture into motion data, and presents a three-dimensional image showing an object or scene in a particular view, where the particular view is based on the motion data derived from the user gesture.

### BACKGROUND

1. Technical Field

The present disclosure relates generally to the presentation of three-dimensional images and more specifically to displaying three-dimensional images of an object in different views according to gestures from a user.

2. Introduction

Kiosks are a popular means for dispensing information and commercial products to the general public. Kiosks can be mechanical or electronic in nature. For example, a mechanical kiosk such as an information booth can carry pamphlets, maps, and other literature that can be picked up by passerby as a means for distributing information. In some instances, an employee sits inside the information booth to dispense or promote the information. However, mechanical kiosks are cumbersome because the literature needs to be restocked and an employee needs to be stationed at the mechanical kiosk.

Another option for dispensing information is an electronic kiosk. An electronic kiosk is a stationary electronic device capable of presenting information to a passerby. An example of an electronic kiosk is an information booth in a shopping mall where a passerby can retrieve information such as store locations on a display by pushing buttons on the electronic kiosk. However, electronic kiosks are simplistic in their presentation of information and can be difficult to operate. These shortcomings are particularly apparent when the information presented is complicated in nature.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for presenting images representing different views of an object or scene to a user. The method includes detecting a user entering a space capable of tracking movement of the user, presenting a three-dimensional image showing an object in a first view to the user when the user enters the space, detecting a user gesture, converting the user gesture into motion data; and presenting, to the user, another three-dimensional image showing the object in a second view based on the motion data. The method can be implemented in software that can be performed by an information kiosk.

A user-interactive system configured to present 3D images showing different views of an object or scene based on user gestures can trigger a motion detection device configured to detect a gesture from a user, a processor configured to produce a three-dimensional image showing an object in a view, wherein the three-dimensional image is produced according to the gesture, and a display configured to present the three-dimensional view to the user. The user interactive system can be part of an information kiosk for providing information to people.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment;

FIG. 2 illustrates an exemplary system with a user interactive three-dimensional display;

FIG. 3 illustrates another exemplary system with a user interactive three-dimensional display;

FIG. 4 illustrates an exemplary user interactive system;

FIG. 5 illustrates a perspective view of an exemplary head-tracking system;

FIG. 6 illustrates an example of determining the field of view of a motion detection device;

FIG. 7 illustrates an exemplary process for presenting a three-dimensional image to a user; and

FIG. 8 illustrates an exemplary use embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

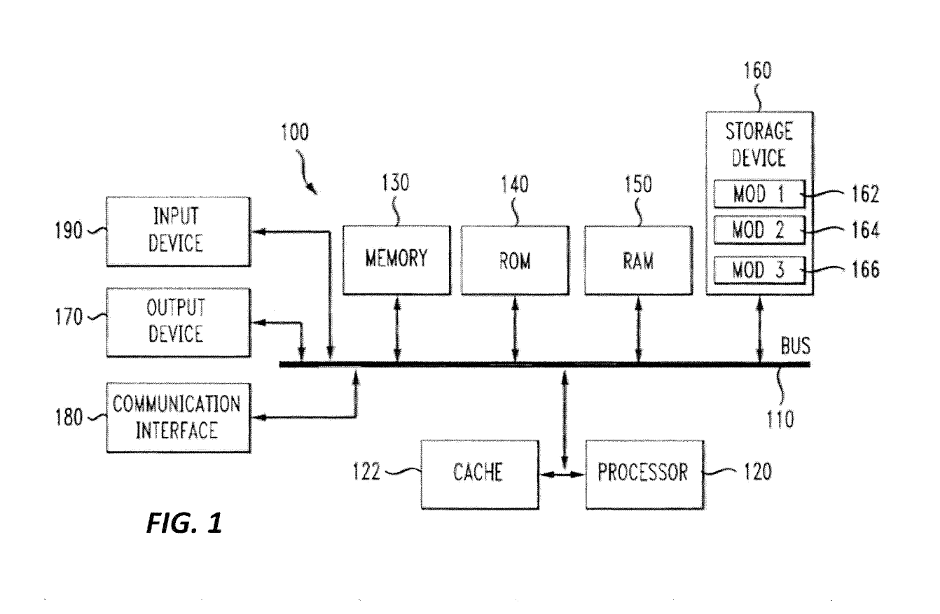

The present disclosure addresses the need in the art for an improved user interface for presenting and manipulating objects and scenes in a three-dimensional (“3D”) space. Objects and scenes can be presented from various angles in a 3D space according to gestures provided by a viewer. As a result, the particular view provided to the viewer can be correlated or associated with the movements or gestures of the viewer. This allows the viewer to manipulate the object in the 3D space and view the object from multiple different angles in a user intuitive and efficient manner. In some examples, the movements and gestures can be intuitive to the viewer, such as the location of the display or screen that the viewer is focusing on. A system, device, method and non-transitory computer-readable media are disclosed which display an object or scene in a 3D space according to movements or gestures provided by the user. Moreover, the system, method and non-transitory computer-readable media can be utilized by the viewer to change the view of the object or scene displayed at a kiosk according to movements or gestures of a viewer. A brief introductory description of a basic general purpose system or computing device that can be employed to practice the concepts is illustrated in FIG. 1. A more detailed description of how the different 3D views are generated will follow. Several variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high-speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware including, but not limited to, hardware capable of executing software and hardware (such as a processor 120) that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now returns to a discussion of displaying an object or scene in a 3D space according to movements or gestures provided by the viewer. The computer system can be part of a kiosk, information system, image processing system, video projection system, projection screen, or other electronic system having a display. The approaches set forth herein can improve the efficiency, user operability, and performance of an image processing system as described above by providing a user intuitive interface for viewing and manipulating different views of an object or scene.

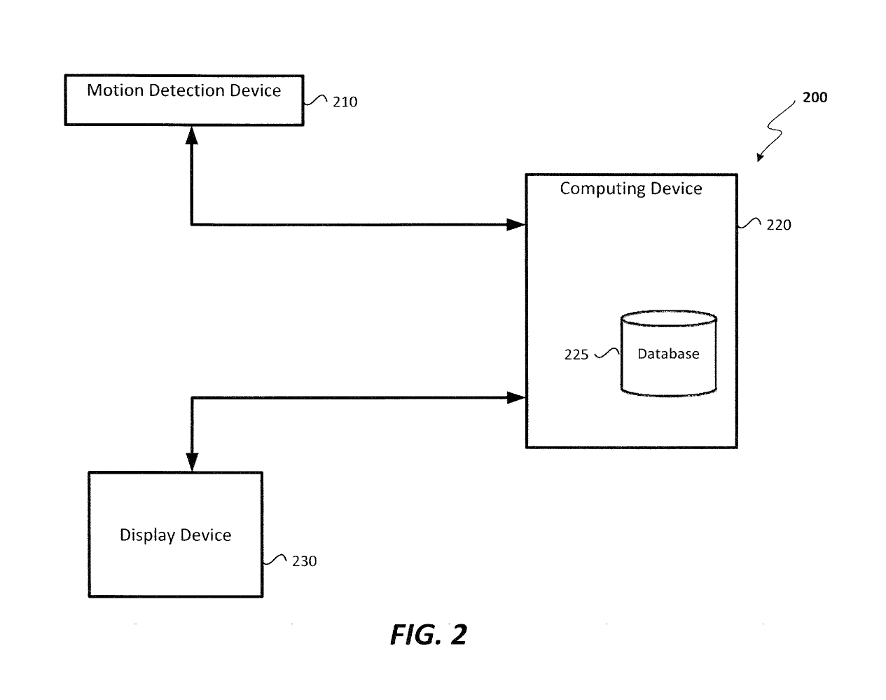

FIG. 2 illustrates an exemplary system with a user interactive three-dimensional display. System 200 is configured to present an object or scene to a user where the view of the object or scene presented to the user can change depending on the user's gestures or movements. The view of the object or scene can change by rotating the object or scene along an axis in the three dimensional space or moving the object to another location in the three dimensional space. The view of the object or scene can also change by changing the vantage point of the user. The vantage point can change if the user views the object from a different location, thus generating a different view. As an example, a person looking at a piece of fruit placed on a table can see the fruit in many different views. The view of the fruit can change if the fruit is rotated clockwise, if the fruit is moved, or if the person were to crouch. In this invention, view of the object or scene can change according to gestures or movements created by the user. The gestures or movements can be intentional such as hand gestures. The movements can also be user intuitive or unintentional. For example, a movement can be simply focusing on a portion or area of the displayed image. In one embodiment, the user's perspective or perceived point of view can change in accordance to the head and eye position with respect to the display. The eye position can be found by locating the center of the user's head and subsequently determining the eye locations relative to that point. The focus point of the eyes at the eye locations can be determined and system 200 can use that determined information to generate or select the view. The elements in the composition shown on the display can additionally be manipulated by body and hand gestures. Thus, the perspective of the view can be manipulated by head and eye tracking while particular elements in the scene can be selected and manipulated with hand and body gestures. In some examples, the hand and body gestures include direct interaction with the kiosk, including but not limited to a touch screen or virtual or physical keyboard interface. For example, a user can select/manipulate elements in the scene or manipulate the entire scene by entering commands on a touch screen display. It is to be understood by those of skill in the art that the scene can be manipulated via a combination of direct and indirect interaction with the kiosk.

In this example, system 200 includes motion detection device 210, computing device 220, database 225, and display device 230. Motion detection device 210 can be any device configured to detect gestures or movement. The range of detection can be limited to a predetermined space or area. As an example, the motion detection device 210 can detect a predetermined space or area in front of motion detection device 210. The predetermined space or area can be a fixed width and/or height and span a fixed distance in front of a camera or sensor of motion detection device 210.

Motion detection device 210 contains both software and hardware. In some embodiments the motion detection device can include a combination of components in exemplary computing system 100. In other embodiments, the motion detection device can be an input device 170 into computing system 100. In either embodiment, the hardware of motion detection device 210 can include one or more sensors or cameras configured to detect motion. The sensors can detect motion visually, audibly, or through radio, microwave, infrared, or electromagnetic signals. Exemplary sensors include acoustic sensors, optical sensors, infrared sensors, magnetic sensors, laser, radar, ultrasonic sensors, microwave radar sensors, and others. In some embodiments the one or more cameras or sensors measure the distance between the cameras or sensors and the user. For example, the motion detection device can include a distance detection device such as an infrared emitter and receiver such as a RGB camera. In some embodiments a sonar or other radio frequency ranging mechanism can also be used to determine distance. In some embodiments distance can be determined by multiple cameras configured to capture 3-D images.

Depending upon the sensor, the sensing area can vary. Movements within the sensing area are converted into data. The data is subsequently processed by software configured to perform one or more motion detection processes, such as skeletal tracking or head tracking to name a few. In some examples, selection of the proper motion detection process can depend on the movement system 200 is tracking. In skeletal tracking, movements of the skeletal system such as the arms, legs, or other appendages of the body are tracked by the sensor or camera. In head tracking, movements of the viewer's head are tracked by the sensor or camera. Depending on the desired interface, a motion detection process can be selected. Software such as facial recognition, and face tracking software can be added to the motion detection process in order to help improve the accuracy of the detection. For example face tracking software can help locate the viewer's face or help locate the focus point of the viewer's eyes. As an example, skeletal tracking systems can be used to locate the center of the user's head (i.e., head location), and to determine the position of the user's eyes relative to that head location (i.e., eye locations). Algorithms can be applied to identify eye locations or other features by extracting landmarks from an image of the user's face. For example, measurements can be taken at or around the eye locations to determine the focus point of the viewer's eyes. In other examples, different motion detection processes can be combined or other processes for tracking motion can also be incorporated. In yet other examples, the user can hold or attach an item to the user's body that is easily tracked by the motion detection device. This can result in more accurate results from detecting the user's movements. For example, a pair of eyeglasses or other prop with markings, imprints, or made of special material can be recognizable or detectable by the motion detection device 210. Thus by the user wearing the pair of eyeglasses, the motion detection device can obtain more accurate measurements of the user's movements. Other accessories that can be worn by the user can also be used. Data collected from the movements can include location, direction, velocity, acceleration, and trajectory.

In some examples, system 200 can include one or more processors configured to translate the viewer's movements into gestures, which in turn provides instructions on how to alter the object or the scene. Depending on the refresh rate of the display or the rate the processor(s) transmits a new image, the processor(s) can also be configured to combine the adjustments from several instructions into a single instruction. The processor(s) can be partially or entirely located in the motion detection device 210 or the computing device 220.

Motion detection device 210 is connected to computing device 220. Computing device 220 is configured to receive data associated with the user's movements or gestures as input and to manipulate, adjust, and process a 3D image or scene according to the received input until the image is at a desired view. In some examples, the desired view can be the user's perspective. Thus, the 3-D image changes based on where the user is viewing the display. Motion detection device 210 can also modify the 3D image to adjust for parallax that may occur when changing the view of the 3D image. Other modifications can include digital paint work, augmenting light and particle effects, rotoscopy, and careful projection of footage and digital paint work with the goal of creating the illusion of a 3D space.

Computing device 220 includes database 225. Database 225 can be configured to store 3D images or scenes that can be manipulated by the computing device to form a 3D image having a desired view. Operational commands and instructions necessary to operate system 200 can also be stored in database 225. Computing device 220 can also include one or more user interfaces for selecting a 3D image to manipulate, for receiving 3D images to be stored in database 225, or other actions. The 3D images stored in database 225 can be received from an external source or alternatively, can be images captured by the motion detection device 210. In some examples, a special gesture from the user can be used to select a 3D image for manipulation. In yet other examples, the connection between the motion detection device 210 and the computing device 220 can be bi-directional where the computing device transmits signals or instructions to motion detection device 120 for calibrating the motion detection device 210. In some embodiments computing device 220 is configured to download or otherwise receive 3-D images, while in some embodiments, computing device 220 is further configured to create 3-D images from existing 2-D images. In such embodiments, the computing device can analyze two or more existing 2-D images of the same object and use these images to create stereoscopic pairs. Using depth creation, element isolation, and surface reconstruction, among other techniques the computing device can automatically create a singe 3-D or virtual 3-D image. In some embodiments, touch up work from an artist can be required. In other examples, 2-D or 3-D images can be captured from the motion detection device 210. The captured images can be used to create the 3-D image for display or alternatively, be combined with a 2-D or 3-D image to place the user within the 3-D image for display.

Computing device 220 is connected to display device 230. Display device 230 is configured to receive image data from computing device 220 and display the image data on a display screen. The display screen can be a surface on which display device 230 projects the image data on. For example, display device 230 can be a television screen, projection screen, video projector, or other electronic device capable of visually presenting image or video data to a user. In some examples, the image data can be configured to generate a diorama-like view on the display screen. In other words, the image data can be generated with the intent of producing a view of an object or scene such that the object or scene appears as if the display screen is a window into a diorama behind the display screen. In some examples, the view generated on the display screen can require special glasses to see the 3D image. In yet other examples, techniques such as autostereoscopy can be used so that the 3D image is viewable without requiring special headgear. Together, the motion detection device 210, computing device 220, and display device 230 can form a system capable of displaying a user interactive 3D image. The displayed 3D image can provide feedback to the user as the user's movements or gestures change the view of the 3D image. System 200 can also be adaptive. In other words, system 200 can adopt its sensitivity to accommodate the user's movements after a period of use. In some examples, the connection between the computer device 220 and display device 230 can be bi-directional. This allows display device 230 to communicate information related to its configuration such as refresh rate, screen dimensions, resolution, and display limitations to computing device 220. This can allow computing device 220 to adjust its settings and parameters during initialization of system 200 and thus deliver image data that is optimized for display device 230. In some examples, system 200 can be incorporated as part of a kiosk or information station to provide information to visitors or people passing by. In other examples, system 200 can be incorporated as part of a computer system where the motion detection device 210 provides input to the computer system and the output of the computer system is displayed on display device 230.

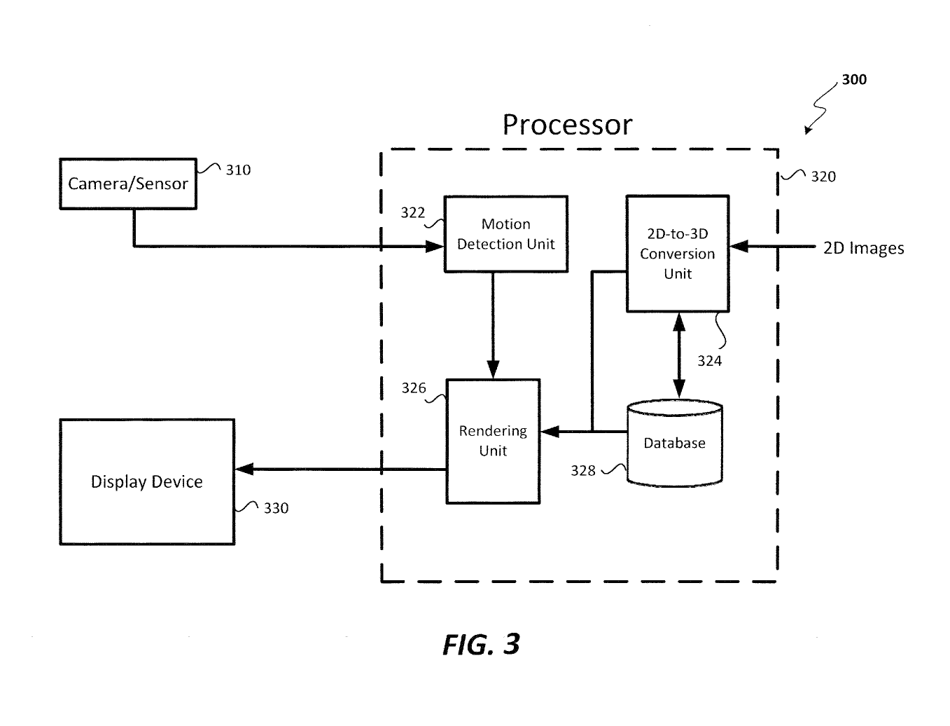

FIG. 3 illustrates another exemplary system with a user interactive three-dimensional display. Similar to system 200 of FIG. 2, system 300 is configured to present an object or scene to a user where the view of the object or scene presented to the user can change depending on the user's gestures or movements. The user's gestures or movements can interact with system 300 directly (e.g., input via keyboard or touch screen) or indirectly (e.g., input via sensing devices). System 300 is further configured to convert two-dimensional (2D) images into 3D images. In this example, system 300 includes camera 310, processor 320, motion detection unit 222, 2D-to-3D conversion unit 324, rendering unit 326, database 328, and display device 330. Camera 310 can be configured to detect motion in the same or substantially the same way as the sensors in motion detection device 210 of FIG. 2. When powered, camera 310 records user movement captured by at least one lens of camera 310 and generates motion data based on the user movement or gestures. The motion data is transmitted to processor 320 to manipulate a 3D image into a particular view, the 3D image then being transmitted to display device 330 for presentation to the user. More specifically, camera 310 transmits the motion data to motion detection unit 322 of processor 320. Motion detection unit 322 converts the motion data into instructions which can be interpreted by processor 320 for rotation (either along a point or axis) or movement of the object or scene for the purpose of generating a particular view of the object or scene. In other examples, the motion data can be used to select a 3D image from a plurality of 3D images displaying the object or scene in various views. The motion data can also be converted into commands to control processor 320. These commands can change the operating mode of system 300, select an object or scene to manipulation in 3D space, or others.

Processor 320 also includes 2D-to-3D conversion unit 324. 2D-to-3D conversion unit 324 is configured to receive 2D images and output a 3D image based on the 2D images. As shown in this example, the 2D images can be received by processor 320 from an external source or from database 328. In other examples, the 2D images can also be received from an image capturing device of system 300 (such as camera 310). Multiple 2D images from different vantage points are received and compared against one another to determine the relative depth of objects in the image. This relative depth information that has been interpolated from the 2D images is used in properly distancing objects from one another in the image. 2D-to-3D conversion unit 324 can use the relative depth information along with the 2D images to generate a 3D image that includes many virtual layers, where each layer contains objects at a particular depth, thus resulting in a layered series of virtual flat surfaces. When viewed at the same time, the series of virtual flat surfaces create the illusion of a 3D image. In some examples, post processing can also be applied to improve the illusion of a 3D space from the 2D images. Post processing can include digital paint work, augmenting light and particle effects, rotoscopy, calculated projection of footage, and algorithms to compensate for parallax. Other algorithms that can be applied include stereoscopic extraction and 2D-to-3D conversion. Once the 3D image is generated by 2D-to-3D conversion unit 324, the 3D image can be transmitted to database 328 for storage or transmitted to rendering unit 326 for manipulation. In some examples, the 2D images are associated with images that would be captured separately by a person's left and right eye. In some embodiments, some surfaces can be entirely reconstructed to fill in views of an object that are not found in any available 2-D view. In some embodiments, only a partial 3-D rendering might be possible, thus limiting the available views of an object. For example, in some instances it might not be possible to create an entire 360 degree view around a given object. Instead 3-D rendering may only be available from perspectives ranging from 0-180 degrees along an X and/or Y axis.

Processor 320 also includes database 328. Database 328 can be configured similar or substantially similar to database 225 of FIG. 2. Database 328 can store pre-processed 2D images or post-processed 3D images. Database 328 can also store commands or instructions that make up the software for managing and controlling processor 320. As shown here, database 328 is coupled bi-directionally to 2D-to-3D conversion unit 324. This can allow database 328 to provide 2D images to the conversion unit and also receive processed 3D images for storage. The stored 3D images can be retrieved by rendering unit 326 for manipulation before presenting to the user.

Rendering unit 326 is connected to motion detection unit 322, 2D-to-3D conversion unit 324, and database 328. Rendering unit 326 can receive one or more images from 2D-to-3D conversion unit 324 and database 328. Rendering unit 326 can also receive instructions for manipulating the view from motion detection unit 322. Rendering unit 326 can process the image similarly or substantially similar as computing device 220 of FIG. 2. This can include manipulating or processing the received image to change the view of the image according to the instructions received from motion detection unit 322.

Processor 320 is connected to display device 330 through rendering unit 326. The processed image can be transmitted from rendering unit 326 to display device 330. Display device 330 can present the image on a screen or other visual medium for the user to view. In some examples, system 300 can be configured to dynamically detect motion from camera 310 and subsequently use the detected motion to change the view of the object or scene presented on display device 330. With sufficient processing power from processor 320, the transition from detecting motion by camera 310 and displaying the respective view associated with the motion on display device 330 can be smooth and continuous. In other examples, processor 320 can be configured to generate low resolution images of the object or scene for display on display device 330 as the user's movements are being captured by camera 310. These low resolution images are called previews of the actual image. Due to processing constraints of system 300, the previews may allow the user to quickly gain feedback on the particular view being generated. Once the user is satisfied with the view (e.g., camera 310 detects no user movements that can be translated into instruction), processor 320 can generate a full or high resolution image of the scene to be displayed on display device 330. Processor 320 can determine whether the user is satisfied with the view provided by the preview by comparing the period of inactivity in user movements with a predetermined threshold. This can allow system 300 to display high resolution 3D images while at the same time providing good performance.

System 300 can also be configured to create and display a limited set of views of the object or scene. As an example, rendering unit 326 can be configured to generate instructions that alter the view incrementally. Therefore, a user gesture received to rotate the object or scene would result in the object displayed rotated by a fixed number of degrees for each instance that the user gesture is received. As another example, a limited set of views of the object or scene can be stored in database 328. Depending on the current image shown and instructions received from motion detection unit 322, rendering unit 326 can select one of the limited set of views of the object or scene to transmit to display device 330 for presentation to the user. By limiting the number of views available to the user and therefore the number of views that need to be generated and supported, system 300 requires less processing power.

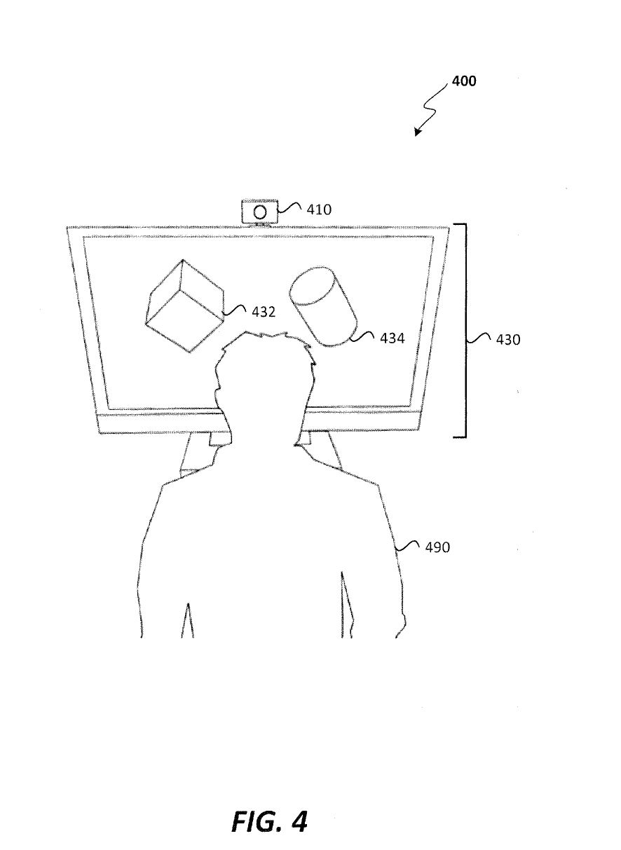

FIG. 4 illustrates an exemplary user interactive system. User interactive system 400 includes a motion detection device 410 and display 430. Motion detection device 410 can be similar or substantially similar to motion detection device 210 of FIG. 2 or camera 310 of FIG. 3. As shown here, motion detection device 410 is mounted on top of display 430. However in other examples, motion detection device 410 can also be mounted on other edges of display 430, embedded within display 430, or can be a standalone device not mounted on or embedded in display 430. Display 430 can be similar or substantially similar to display device 230 of FIG. 2, or display device 330 of FIG. 3. Display 430 is shown as a television screen but in other examples, display 430 can also be a projection screen or other device capable of generating an image viewable by user 490. Together, user interactive system 400 can be combined with other hardware and software to form a kiosk or information system.

As shown here, display 430 is displaying object 432 and object 434. Object 432 and object 434 are presented at a particular view that is viewable by user 490. Through movements from the body of user 490, object 432 and 434 can be rotated along an axis or moved to other locations of display 430. In some examples, specific movements or gestures from user 490 can be mapped to specific commands to change the view of object 432 and 434. For example, a head rotation along a particular axis can be translated to a rotation of object 432 and/or object 434 along the same axis. Thus, rotating the head to the left by 15 degrees can result in object 432 or object 434 rotating to the left by 15 degrees. As another example, hand gestures (hand lifting up, hand pressing down, hand turning a knob, etc.) can be translated to similar rotations and movements of object 432 and/or object 434 in a manner that would be intuitive and user-friendly. In yet other examples, gestures from one appendage of user 490 can be associated with one object while gestures from another appendage of user 490 can be associated with another object. Thus, one appendage can be used to control the view of object 432 while another appendage can control the view of object 434. Alternatively, system 400 can be configured such that one appendage of user 490 controls manipulation of the object or scene in one manner such as movement while another appendage of user 490 controls manipulation of the object or scene in another manner such as rotation. In yet other examples, movements from user 490 can be tracked by motion detection device 410 and translated into different manipulations of objects 432 and 434 on display 430.

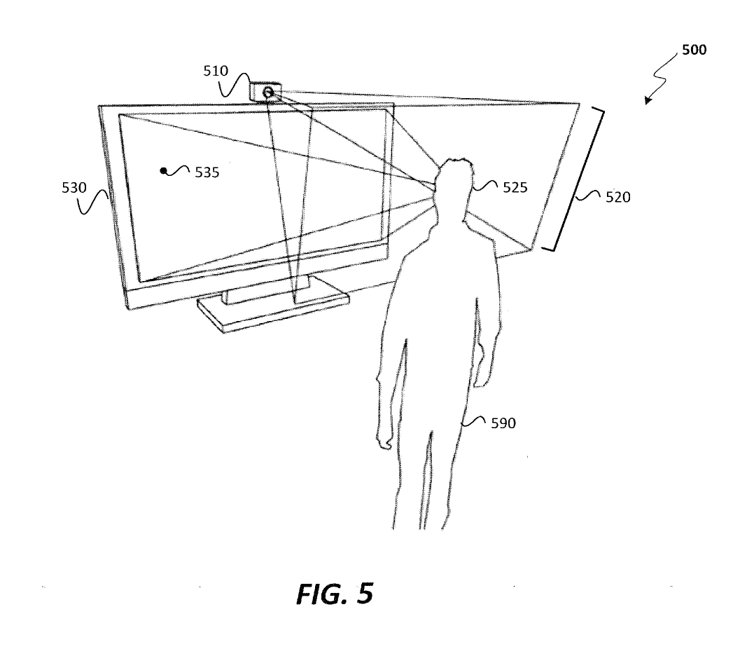

FIG. 5 illustrates a perspective view of an exemplary head-tracking system. Head-tracking system 500 includes motion detection device 510, display 530, and user 590. Motion detection device 510 can be similar or substantially similar to motion detection device 210 of FIG. 2, camera 310 of FIG. 3, or motion detection device 410 of FIG. 4. Motion detection device 510 is mounted on top of display 530. Display 530 can be similar or substantially similar to display device 230 of FIG. 2, display device 330 of FIG. 3, or display device 430 of FIG. 4. Together, head-tracking system 500 can be combined with other hardware and software to form a kiosk or information system.

Motion detection device 510 is capable of tracking head motion within a predetermined space, also known as the sensing space. The sensing space can be dependent on the user's distance from the motion detection device 510, the field of view of the motion detection device 510, optical or range limitations of the sensor, or other factors. In this example, user 590 is standing a distance from motion detection device 510 that results in a sensing space of sensing area 520. Motion detection device 510 detects the head of user 590 at location 525 of sensing area 520 and generates location data based on location 525. The location data is metadata associated with the current position of user 590's head in the sensing area 520. Motion detection device 510 can also determine the focus point 535 of user 590 on display 530. This calculation can be determined by measuring the angle of user 590's head or eye tracking, or both, and subsequently interpolating the area of display 530 that the user is focusing on. The accuracy of the focus point can vary depending on software and hardware limitations of motion detection device 510. A processor can receive the location data, the focus point, or both, and transmit a particular view of an object or scene to display 530 for presentation to user 590, where the particular view is based on the location data, the focus point, or both.

Motion detection device 510, with the use of hardware or software, can take measurements associated with the location and physical attributes/gestures of the user to calculate the location data and the focus point. In one embodiment, motion detection device 510 can measure or calculate the perpendicular vector from the user's viewpoint to the plane of the display, the offset angle from the user's viewpoint to the center of the display, or the offset distance from the user's viewpoint to the center of the display. These values and others can be used in calculations used in generating the object or scene in a viewpoint associated with the physical location of the user and the place on the display that the user is focusing on. For example, a given viewpoint can have certain objects in the foreground that appear closer to the user when compared with another viewpoint. For instance, let's assume the scene includes an automobile viewed from the side. The headlights of a vehicle can appear larger when a user is standing on the side of the display that is closer to the front of the automobile. In contrast, the taillights of the vehicle can appear larger to the user if the user is standing on the side of the display that is closer to the rear of the automobile. Mathematical transformation equations such as the offset perspective transform can be used to calculate and generate the scene or object. For example, the D3DXMatrixPerspectiveOffCenter function from the DirectX application or the glPerspective( ) function from OpenGL can be used. In some examples, the equations calculated and the measurements taken can depend on the complexity of the 3D image generated.

As described above, the motion detection device transmits information to the display for providing a user with a unique viewing experience from the viewpoint of the user. Since the user focuses on the display while generating commands to edit the view, calibration can be required so that the motion detection device can properly track the movements of the user. Calibration can be performed when originally setting up the system or alternatively, whenever the motion detection device or display is powered on. Calibration can involve setting one or more of the following values in the system. Other relationships between the motion detection device and the display can also be measured and used for calibration.

The location of the motion detection device with respect to the location of the display can be set. The positional relationship between the physical location of the motion detection device with respect to the physical location of the display can be measured to calculate an offset. The offset can be used to calibrate motion detection device for the neutral position of the user as he views the display. The positional relationship can be measured by the distance between the motion detection device and the center point of the display. Alternatively, the positional relationship can be measured by the horizontal and vertical angle difference between the lens of the motion detection device and the display.

The display configuration can be measured and transmitted to motion detection device for calibration of the motion detection device. The configuration can include the size, resolution, and refresh rate of the display screen. This information can be used to calibrate the attributes of the motion detection device. For example, the resolution and the refresh rate can be used to set the optimal resolution and frame rate that the motion detection device should capture in given the display configuration. For example, the size of the display can be used to define the working area of the system. This can prevent user movements outside the working area of the system to not be translated into commands. For example if the user's head focuses on an area not on the screen of the display, the motion detection device should be configured to not interpret that user movement as a command to manipulate the view of the image. This can be important to allow the system to determine when the user is looking at the display versus away from the display. In some examples, the system can check if the user is looking at the display before allowing user movements to be translated into commands.

In other examples, system 500 can be configured for use in conventions, museums, public places, trade shows, interactive movie theater, or other public venue having video projectors or projection screens. For instance, display 530 can be a video projector or projection screen. The screen can be flat, curved, dome-like, or other irregular or regular projection surface. Irregular projection surfaces can be corrected for spatial disparity via algorithms performed by a rendering unit such as rendering unit 326 of FIG. 3. The video projectors or projections screens can be configured to allow a visitor of the public venue to interact with the projected scene via deliberate movements such as hand gestures or intuitive movements such as rotation of the head or the focus point of the user's eyes.

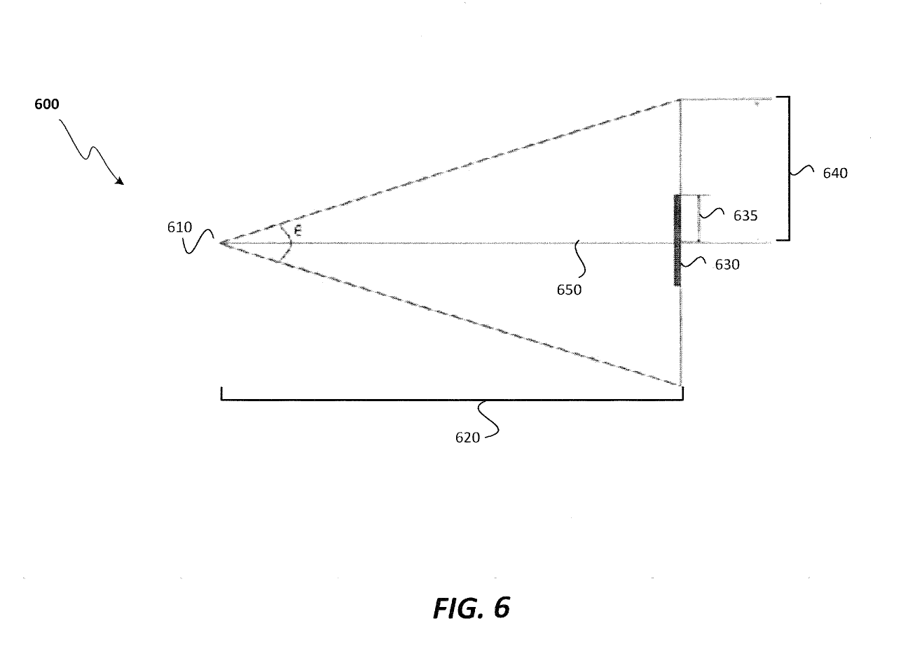

The hardware of the motion detection device can also be calibrated. This can include determining the field of view of the motion detection device. The field of view can be directly related to the sensing area where user movements can be recorded. Thus, the field of view of the motion detection device is directly related to the motion detection device's ability to track movement. FIG. 6 illustrates an example of determining the field of view of a motion detection device. System 600 includes lens 610 of the motion detection device and fiducial image 630. Fiducial image 630 can be a card containing a pattern understood by the calibration software. In some examples, the card contains a black and white printed image printed on a card or a card containing holes that can be detected by a range camera. As shown in FIG. 6, a user can hold fiducial image 630 a fixed distance from lens 610. The calibration software can calculate the field of view 610 by solving the following equation:

$$θ = 2 \cdot ATan ( \frac{m}{d} ) = 2 \cdot ATan ( \frac{\text{?}}{r \cdot d} )$$

$$where \text{:}$$

$$r = \frac{\text{?}}{\text{?}} is the ratio of the screen fiducial takes up$$

$$\text{?} \text{indicates text missing or illegible when filed}$$

where wₚ is the measured width 640 of the camera projection, f is half the actual width 635 of the fiducial, and d is distance 650.

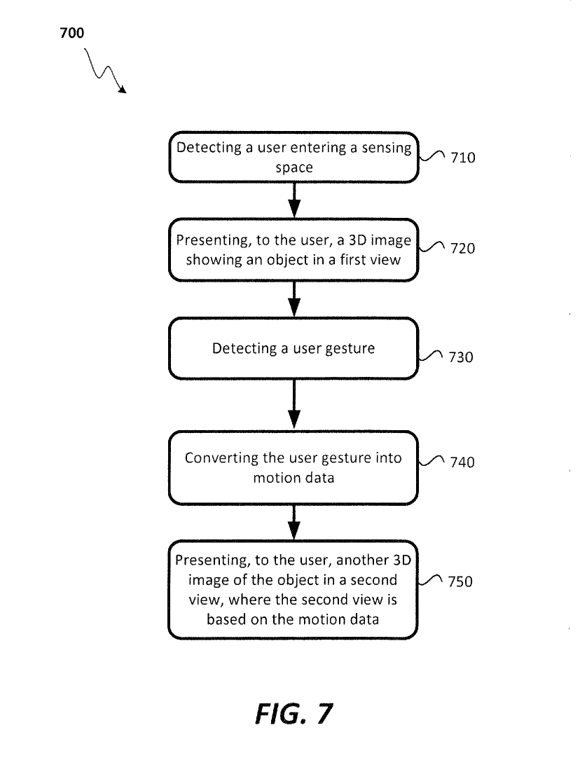

FIG. 7 illustrates an exemplary process for presenting a three-dimensional image to a user. Computer software code embodying process 700 can be executed by one or more components of system 200 of FIG. 2, system 300 of FIG. 3, system 400 of FIG. 4, or system 500 of FIG. 5. Process 700 detects a user entering a sensing space at 710. The detection can be performed by a sensing device such as a camera. The camera can operate in a low power or low resolution state while detecting motion in the sensing space. In the low power or low resolution state, the sensitivity of the camera can be diminished. Once motion has been detected, the camera can enter a normal state with normal sensitivity. Process 700 can present to the user a 3D image showing an object or scene in a first view at 720. The first view can be predetermined or based on positional information of the user in the sensing space. Process 700 can subsequently detect a user gesture at 730. The user gesture can be detected by the camera or be based on user movements captured by the camera. Process 700 can convert the user gesture into motion data at 740. The motion data can describe the user's intended manipulation of the 3D image from the provided user gesture. Process 700 can then present another 3D image showing the object in a second view based on the motion data at 750. The another 3D image can be selected from a plurality of available 3D images illustrating the object in different views. Alternatively, the another 3D image can be generated by a processor from one or more images or data associated with the object. In other exemplary processes, the process can be simplified from process 700 by removing one or more operations. For example, another exemplary process can detect a user gesture, generate a 3D image of the object in a view according to the user gesture, and then present the 3D image to the user.

In some embodiments the presently disclosed technology can be used as a kiosk for displaying advertisements or other objects/products to users. In one example, a kiosk can be placed in a mall environment wherein mall patrons walk by the kiosk. Patrons that walk within an area detectable to a sensor that is part of the kiosk system can be detected, and an advertised product can be displayed according to their viewpoint.

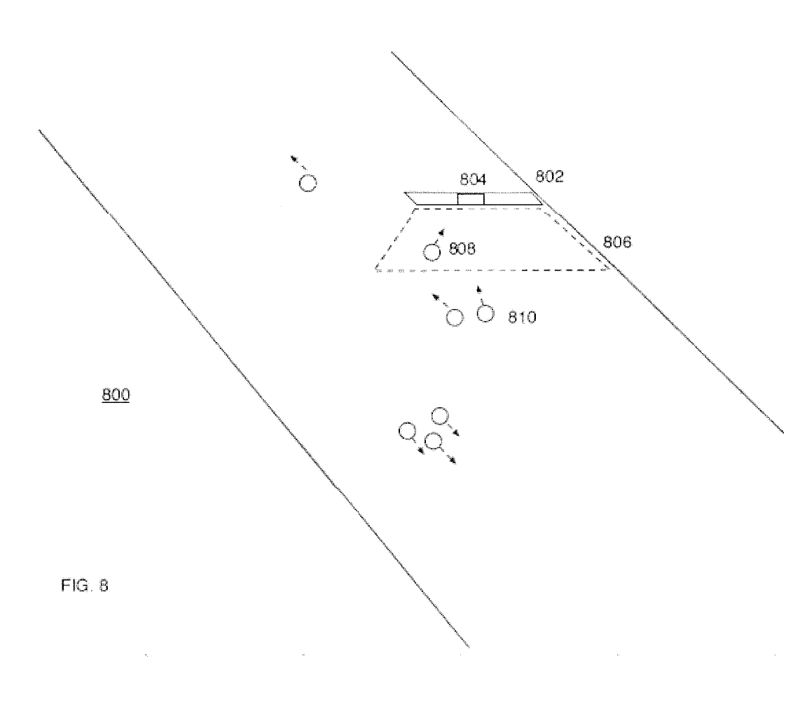

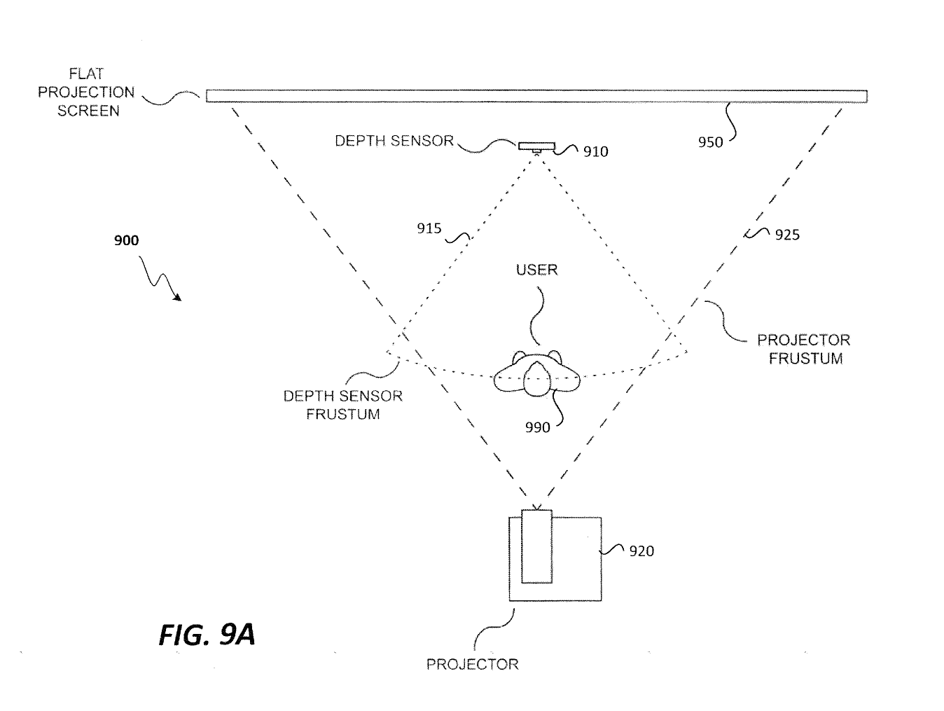

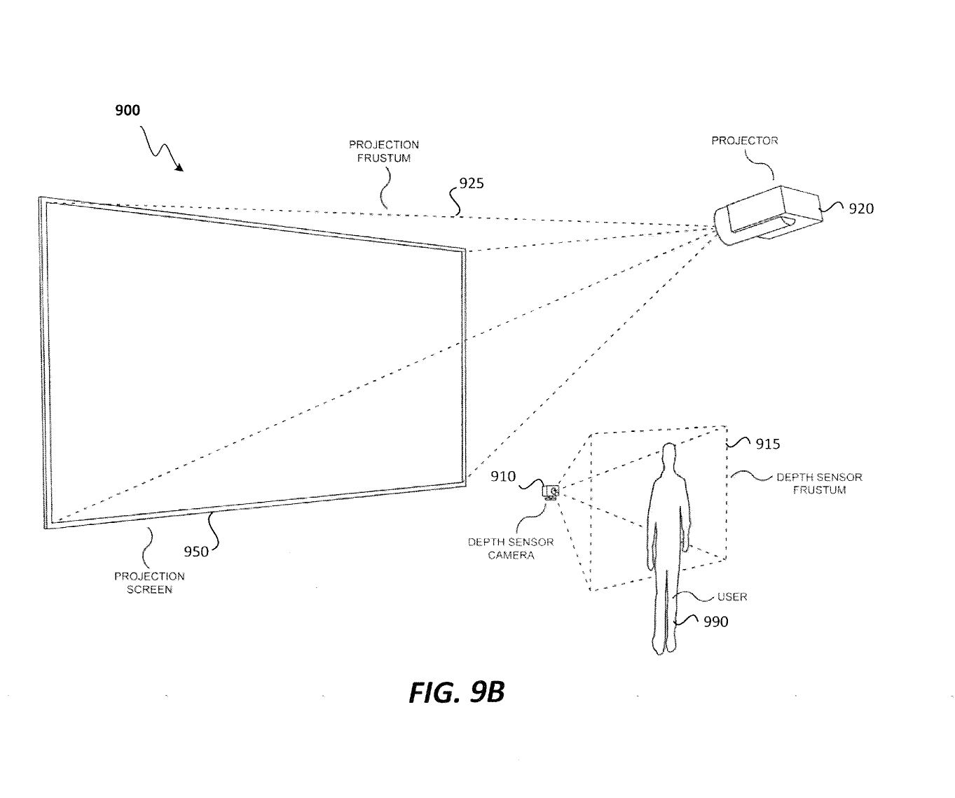

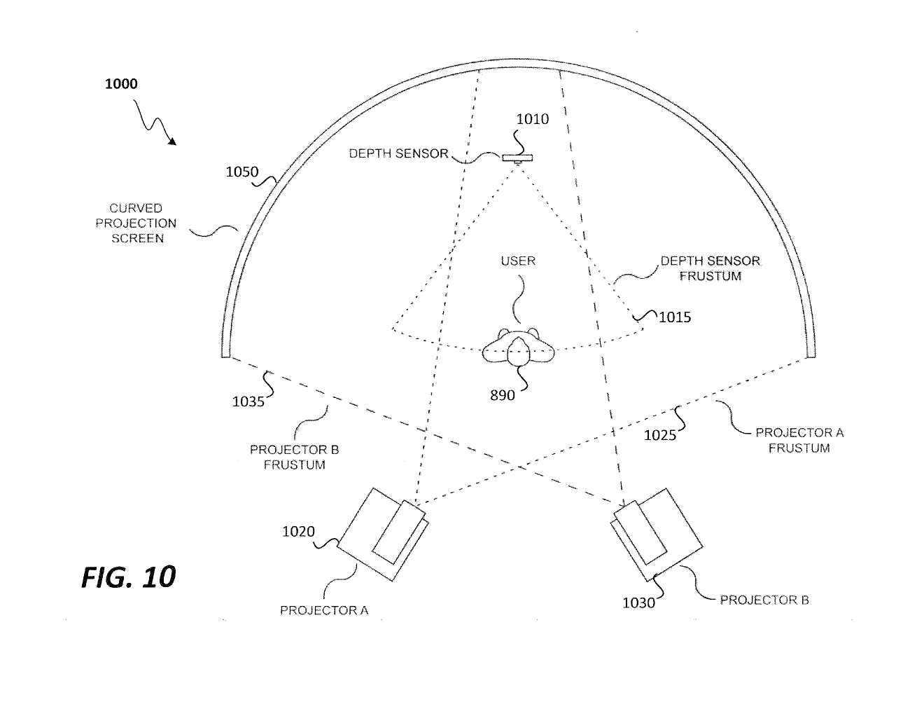

FIG. 8 illustrates such an embodiment in scene 800 shown from a top-down view. Display 802 having a sensor 804 is illustrated in a hallway. Sensor 804 has a detectable range depicted by the dotted area 806. Patrons 808, 810 walking along the hallway that walk within the detectable range and that are looking at the display can be shown an image, such as an image advertising a product. Patrons 808, 810, and others are shown having a dashed arrow extending from them. The dashed arrow illustrates the direction of the patrons' gazes. While patrons 808 and 810 are both looking at the display only patron 808 is recognized as being within the detectable area, and thus the kiosk can display an image directed at patron 808's viewpoint and shown according to patron 808's respective parallax. As the patron continues to walk through the detectable area 806 the image can either rotate with the patron or additional surfaces on the virtual 3-D image can become visible to the patron according to the change in patron 808's parallax.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc., that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A system, comprising:
a motion detection device configured to detect a physical attribute of a user;
a processor configured to render a three-dimensional image in a perspective based in part on the physical attribute of the user; and
a display configured to present the three-dimensional image to the user.

2. The system of claim 1, wherein the motion detection device, the processor, and the display are components of a kiosk.

3. The system of claim 1, wherein the motion detection device comprises a camera configured to visually track a first direction of a user's gaze.

4. The system of claim 3, wherein the camera tracks an object worn by the user.

5. The system of claim 1, wherein the motion detection device is further configured to recognize facial features of the user.

6. The system of claim 1, wherein the system transitions from a standby state to an active state when the motion detection device detects the user entering a space that is detectable by the motion detection device, wherein at least one of the processor and display are in a sleep mode when the system is in the standby state.

7. The system of claim 1, wherein the physical attribute is based on the head or eyes of the user and the three-dimensional image shows the object in the viewpoint of the user.

10. A method, comprising:
detecting a user entering a space capable of tracking movement of the user;
presenting a three-dimensional image showing an object in a first view to the user when the user enters the space;
detecting a user gesture;
converting the user gesture into motion data; and
presenting, to the user, another three-dimensional image showing the object in a second view based on the motion data.

11. The method of claim 10, wherein presenting another three-dimensional image comprises smoothly blending the three dimensional image into the another three-dimensional image.

12. The method of claim 10, wherein detecting a user entering the space and detecting the user gesture are performed by at least one of a range camera and a RGB video camera.

13. The method of claim 10, further comprising:
receiving a plurality of two-dimensional images of the object in different views; and
generating the three-dimensional image from the plurality of two-dimensional images.

14. The method of claim 10, wherein detecting the user gesture comprises detecting movement of an item worn by the user.

15. The method of claim 10, wherein detecting the user gesture comprises detecting movement of at least one of the eye, head, arm, and hand of the user.

16. The method of claim 10, further comprising calibrating a display and a motion detection device.

17. The method of claim 10, wherein the another three-dimensional image is generated in real-time.

18. The method of claim 10, wherein the another three-dimensional image is selected from a plurality of three-dimensional images showing the object in different views.

19. A computer-implemented method for presenting an image to a user comprising:
detecting a user gesture;
converting the user gesture into motion data; and
presenting a three-dimensional image showing an object in a view, wherein the view is based on the motion data.

20. An information kiosk performing the method of claim 10.
